(19) United States
(12) Patent Application Publication
(10) Pub. No.: US 2010/0078849 A1
(43) Pub. Date: Apr. 1, 2010

(54) PROCESS FOR PRODUCING THERMOPLASTIC RESIN FILM

(75) Inventor: MASAHIKO NORITSUNE, MINAMI-ASHIGARA-SHI (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/566,002

(22) Filed: Sep. 24, 2009

(30) Foreign Application Priority Data
Sep. 26, 2008 (JP) 2008-248030

(51) Int. Cl. B29C 43/24

(52) U.S. Cl. 264/175

(57) ABSTRACT

The present invention provides a process for producing a thermoplastic resin film, comprising: a feeding step of feeding a molten resin containing a thermoplastic resin from a feeding device; a heating step of heating the molten resin from a discharge opening of the feeding device to a nip portion between a first compression surface and a second compression surface that are included in a compression apparatus by using a heating apparatus; and a film formation step of continuously compressing the heated molten resin between the first compression surface and the second compression surface to form a film, wherein a pressure applied to the molten resin by the compression apparatus is between 20 MPa or more and 500 MPa or less.

### BACKGROUND OF THE INVENTION

1. Field of the Invention

The present invention relates to a process for producing a thermoplastic resin film, and specifically to a film production technology a thermoplastic resin film produced by which is used in optical applications such as liquid crystal display devices.

2. Description of the Related Art

Thermoplastic resins such as cellulosic resins and cyclic olefin resins are widely used for films for optical applications. Especially, films made of cellulosic resins or cyclic olefin resins are used for optical films for liquid crystal display devices because of their clarity, toughness, and optical isotropy.

A process for producing a thermoplastic resin film is a process where a molten thermoplastic resin is discharged from a die in film form and the discharged film is cooled and solidified with a plurality of chill rolls, for example melt film formation. An unoriented thermoplastic resin film thus produced is used, for example, as protective films for liquid crystal display devices. In addition, a film that has developed retardation by stretching an unoriented thermoplastic resin film is used as a phase difference film for liquid crystal display devices.

However, a disadvantage of the melt film formation is that the film discharged from the die has a decreased temperature and an increased viscosity before the film reaches chill rolls, making it difficult to level the film. For this reason, unfortunately, a film produced by melt film formation has thickness variations in the transverse direction and longitudinal direction (direction in which the resin in film form discharged from the die flows) of the film.

To solve the problem, Japanese Patent Application Laid-Open No. 2007-307896 for example discloses a process for producing a film suitable for optical films that has a low retardation as well as a high thickness precision and a reduced residual strain by heating a molten resin melted with an extruder by using heater heating units during the period from when leaving the die to when coming in contact with the chill rolls, forming a bank portion between a pair of rollers, and maintaining the pressure at which the molten resin is pressed with the rolls small.

Moreover, with the flourishing liquid crystal display market, various films have recently been developed. For example, Japanese Patent Application Laid-Open No. 2003-25414 and Japanese Patent Application Laid-Open No. 2007-38646 disclose processes for producing a film having an inclined optical axis where shear stress is imparted to the produced film by passing a molten resin between two rolls having peripheral speeds different from each other.

### SUMMARY OF THE INVENTION

However, because films for optical applications have recently been required to have higher quality, the process described in Japanese Patent Application Laid-Open No. 2007-307896 no longer provides sufficient retardation, and a film that develops more retardation in the in-plane direction and thickness direction is desired.

In addition, the optical compensation effect is not sufficient just by using a film having an inclined optical axis for liquid crystal displays. For example, Japanese Patent Application Laid-Open No. 2007-38646 discloses an optical film having an inclined optical axis but does not describe the relationship between the angle of inclination of an optical axis and the optical compensation of a liquid crystal display. To actually provide optical compensation to transmissive TN or ECB liquid crystal displays and semi-transmissive ECB liquid crystal displays, an optical film that has a phase difference that can compensate for the retardation of liquid crystal cells and a more inclined structure is desired.

The present invention has been made in light of these circumstances, and an object thereof is to provide a process for producing a thermoplastic resin film that can develop more retardation in the in-plane direction and thickness directions as well as can reduce nonuniform thickness and retardation and prevent non-touch defects.

In order to achieve the above object, a first aspect of the present invention provides a process for producing a thermoplastic resin film, comprising: a feeding step of feeding a molten resin containing a thermoplastic resin from a feeding device; a heating step of heating the molten resin from a discharge opening of the feeding device to the nip portion between a first compression surface and a second compression surface that are included in a compression apparatus by using a heating apparatus; and a film formation step of continuously compressing the molten resin between the first compression surface and the second compression surface to form a film, wherein the pressure applied to the molten resin by the compression apparatus is between 20 MPa or more and 500 MPa or less, in order to achieve the object above.

According to the first aspect, the section from the feeding device to the nip portion between the first compression surface and the second compression surface is heated with the heating apparatus to prevent the temperature of the molten resin fed from the feeding device as much as possible from falling and ensure the desired viscosity, and then the molten resin is passed through the space between the first compression surface and the second compression surface that is at a nip pressure as high as 20 to 500 MPa.

The molten resin that flows down on the upper side of the nip portion between the first compression surface and the second compression surface (hereinafter referred to as the bank portion) speeds up rapidly and is pulled when the molten resin passes through the space between the first compression surface and the second compression surface that is very narrow and at a pressure as high as 20 to 500 MPa, and this action can cause a high retardation to develop in the in-plane direction and the thickness direction of the molten resin. Here, the molten resin extruded from the die passes between the first compression surface and the second compression surface of the compression apparatus and is formed into a film, and the excess thereof is retained on the nip portion between the first compression surface and the second compression surface. As used herein, the upper portion of the nip portion where the molten resin is retained refers to the bank portion.

Moreover, according to the first aspect, the resin is heated by the heating apparatus provided between the feeding device from which the resin is fed and the compression apparatus at which the resin arrives, and this can maintain the resin at the desired viscosity, thereby reducing variations in the thickness of the molten resin and preventing retardation variations.

Therefore, according to the first aspect, retardation can be allowed to develop more in the in-plane direction and the thickness direction, and at the same time thickness variations, retardation variations, and further non-touch defects of the resulting film can be prevented. Especially, the present invention can make it easy to cause retardation to develop in the direction in the in-plane direction in which the molten resin can be allowed to flow.

A second aspect of the present invention is characterized in that in the first aspect, the resin 20 mm above the bank portion that is the upper side of the nip portion between the first compression surface and the second compression surface has a temperature of (Tg+50)° C. or more where Tg is the glass transition temperature of a thermoplastic resin.

According to the second aspect, a molten resin having the desired viscosity can be retained at the bank portion by setting the temperature of the resin 20 mm above the bank portion at or above the temperature mentioned above. Because the compression apparatus is used to apply a high pressure to form the resin into a film, a high retardation can be allowed to develop.

A third aspect of the present invention is characterized in that in the first or second aspect, a travel speed ratio of the second compression surface to the first compression surface of the compression apparatus defined by Eq. 1 below is between 0.6 and 0.99 (both inclusive).

Travel speed ratio=Second compression surface speed/First compression surface speed Eq. 1

According to the third aspect, shear stress can be imparted to the formed film by making the first compression surface and the second compression surface have travel speeds different from each other, and thus allows for the production of a film having a greatly inclined structure. Especially, although in the present invention a film is produced at a high nip pressure and it is expected that this makes the compressive force larger and the sear stress relatively lower, a film having a large angle of inclination can be produced.

A fourth aspect of the present invention is characterized in that in any of the first aspect to the third aspect, the first compression surface and the second compression surface of the compression apparatus are two rolls.

According to fourth aspect, a pressure can easily be applied with the compression apparatus because rolls are used as the first compression surface and the second compression surface.

A fifth aspect of the present invention is characterized in that in any of the first aspect to the fourth aspect, a length from the discharge opening of the feeding device to the nip portion is 200 mm or less.

According to the fifth aspect, the temperature in the transverse direction and the flow direction can be controlled and the viscosity of the molten resin at the bank portion can be ensured by setting the length from the discharge opening of the feeding device to the nip portion at 200 mm or less.

A sixth aspect of the present invention is characterized in that in any of the first aspect to the fifth aspect, the molten resin from the discharge opening of the feeding device to the nip portion and the heating apparatus are covered with a shielding member having a thermal insulation function and/or a reflection function.

According to the sixth aspect, because the molten resin from the discharge opening of the feeding device to the nip portion and the heating apparatus are covered with a shield member having a thermal insulation function and/or a reflection function, the resin can be heated effectively.

A seventh aspect of the present invention is characterized in that in any of the first aspect to the sixth aspect, the film produced has a thickness between 20 μm or more and 100 μm or less, and the in-plane retardation is between 20 nm or more and 200 nm or less.

According to the production process of the present invention, because the molten resin can be passed between the first compression surface and the second compression surface at a high pressure by using the compression apparatus, and then be poured into a narrow clearance from the bank portion at the desired viscosity, retardation can be allowed to develop in the in-plane direction even in producing a thin film having a thickness between 20 μm or more and 100 μm or less.

According to the process for producing a thermoplastic resin film of the present invention, more retardation in the in-plane direction can be allowed to develop significantly, and at the same time, thickness variations and retardation variations in the transverse direction and the flow direction as well as the occurrence of non-touch defects can be reduced.

### BRIEF DESCRIPTION OF THE DRAWINGS

FIG. 1 is a general configuration view of an example of a production apparatus to perform the process for producing a thermoplastic resin film of the present invention;

FIG. 2 is a sectional view of the configuration of an extruder;

FIG. 3 is a schematic view of the configuration between a die and a casting roll;

FIG. 4 is an enlarged perspective view of the configuration between a die and a casting roll;

FIG. 5 is a schematic view of the configuration between a die and a casting roll of another embodiment;

FIG. 6 is an enlarged perspective view of the configuration between a die and a casting roll of another embodiment;

FIG. 7 is a schematic view of the configuration between a die and a casting roll of yet another embodiment;

FIG. 8 is a schematic view of the configuration between a die and a casting roll of yet another embodiment;

FIG. 9 is a conceptual graph showing the relationship between the roll peripheral speed ratio and |Re(40°)−Re(−40°)|;

FIG. 10 is a block diagram when the film produced is stretched in the machine direction and stretched in the transverse direction; and

FIGS. 11A and 11B are tables showing the test conditions and results of the Examples.

### DETAILED DESCRIPTION OF THE PREFERRED EMBODIMENTS

The preferred embodiment of the process for producing a thermoplastic resin film according to the present invention will be described below by referring to the attached drawings.

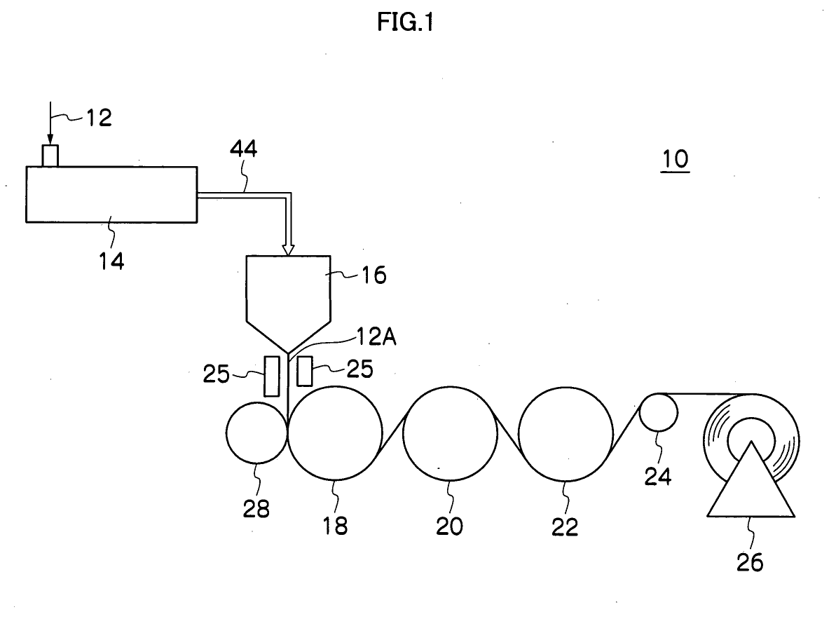

FIG. 1 is a configuration view of an example of a production apparatus to perform the process for producing a thermoplastic resin film of the present invention.

As shown in FIG. 1, a production apparatus 10 includes an extruder 14 that melts a thermoplastic resin-containing composition (hereinafter also referred to as a thermoplastic resin composition) 12, a die 16 that discharges the molten thermoplastic resin composition 12 in film form, a plurality of casting rolls 18, 20, and 22 that subject the film 12A in the high-temperature molten state discharged from the die 16 to multistage cooling, a pull-off roll 24 that separates the film 12A from the last casting roll 22, and a winder 26 that winds up the cooled film 12A.

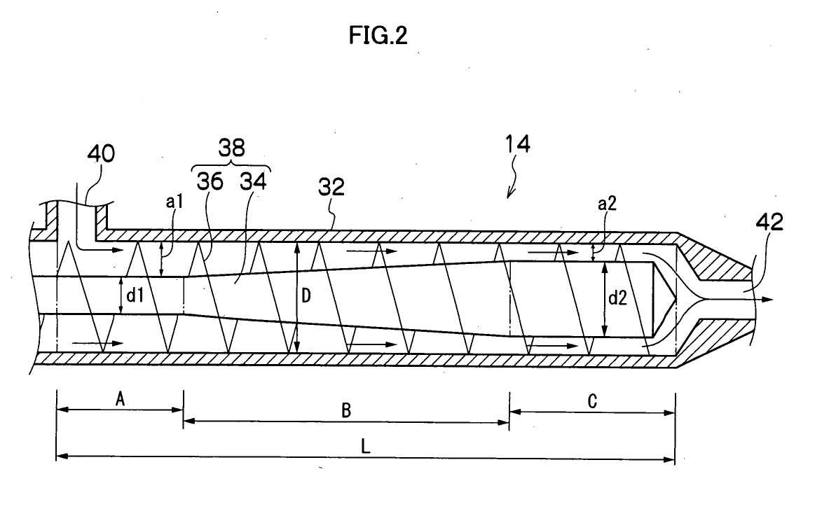

The feeding step is the step of forming a thermoplastic resin-containing composition and feeding the composition to the film formation step. FIG. 2 is a sectional view of the configuration of the extruder 14 as an example of the feeding device. As shown in FIG. 2, a single screw 38 where a screw axis 34 is equipped with a flight 36 is provided in a cylinder 32 of the extruder 14. This single screw 38 is rotated by a motor not shown in the figure. A hopper not shown in the figure is attached to a feed opening 40 of the cylinder 32. And, from this hopper, the thermoplastic resin composition 12 is fed via the feed opening 40 into the cylinder 32.

The cylinder 32 includes, starting from the feed opening 40 side, a feed section (zone marked with A) that conveys the thermoplastic resin composition fed from the feed opening 40 in constant amounts, a compression section (zone marked with B) that kneads and compresses the thermoplastic resin composition, and a metering section (zone marked with C) that meters the kneaded and compressed thermoplastic resin composition. The thermoplastic resin composition melted by the extruder 14 is continuously transported from the discharge opening 42 to the die 16.

The screw compression ratio of the extruder 14 is preferably set at 1.5 to 4.5, and the ratio L/D, which is the length of the cylinder to the inner diameter of the cylinder, is preferably set at between 20 and 70. Here, the screw compression ratio is expressed as the volume ratio of the feed section A to the metering section C, in other words, the volume per unit length of the feed section A divided by the volume per unit length of the metering section C, and calculated by using the outer diameter d1 of the screw axis 34 at the feed section A, the outer diameter d2 of the screw axis 34 at the metering section C, the flight depth a1 at the feed section A, and the flight depth a2 at the metering section C. The extrusion temperature is preferably 190 to 300° C. Moreover, to prevent residual oxygen from oxidizing the molten resin, it is also preferable to fill the extruder with an inert gas (such as nitrogen) or to use a vented extruder to evacuate the extruder while the composition is melted.

Then, the thermoplastic resin composition 12 melted by the extruder 14 is transported via a pipe 44 (see FIG. 1) to the die 16 and discharged in film form through the die discharge opening. Variations in discharge pressure at which the composition is discharged from the die 16 are preferably controlled within 10%.

Here, FIG. 1 illustrates an embodiment which uses an extruder that melts a thermoplastic resin composition and a die that discharges the composition in film form as a feeding device, but the present invention is not limited thereto, and for example, the following film formation step can be conducted by feeding a resin in film form, melting the resin with a heating device to form a molten resin.

In the film formation step, the molten resin formed by the feeding device is continuously compressed between the first compression surface and the second compression surface making up the compression apparatus to form the film 12A. FIG. 1 illustrates an example that uses the touch roll 28 and the casting roll 18 as the first compression surface and the second compression surface making up the compression apparatus. In addition, in the present embodiment, the pressure applied to the melt by the compression apparatus is 20 to 500 MPa. Application of such a large pressure can cause the film 12A to develop retardation in the in-plane direction in the film formation step.

Here, the nip pressure of the compression apparatus can be calculated by compressing Prescale, a pressure measurement film, from FUJIFILM Corporation at a nip point for color development and then converting the degree of color development into a pressure value by using FPD-305, a densitometer for Prescale, and FPD-306, a pressure reader for Prescale.

In addition, the travel speed of the first compression surface is preferably made faster than the travel speed of the second compression surface to provide a difference in peripheral speed. The provision of a difference in peripheral speed can impart shear stress to the formed film and thus cause retardation to develop in the thickness direction. In addition to a combination of two rolls (the touch roll 28 and casting roll 18) having peripheral speeds different from each other as shown in FIG. 1, examples of compression apparatuses where the first compression surface and the second compression surface have speeds different from each other include the combination of a roll and a touch belt having speeds different from each other described in Japanese Patent Application Laid-Open No. 2000-219752. Among these apparatuses, two rolls having peripheral speeds different from each other are preferable in view of making it difficult for the compression surfaces to slip when a difference in peripheral speed is provided. Roll pressure can be measured by passing a pressure measurement film (e.g., Medium Pressure Prescale from FUJIFILM Corporation) between the two rolls.

As shown in FIG. 1, a set of three casting rolls 18, 20, and 22 are arranged downstream of the die 16. The casting roll 18 is configured to cool and solidify a resin by sandwiching the resin between the roll and the touch roll 28 placed adjacently.

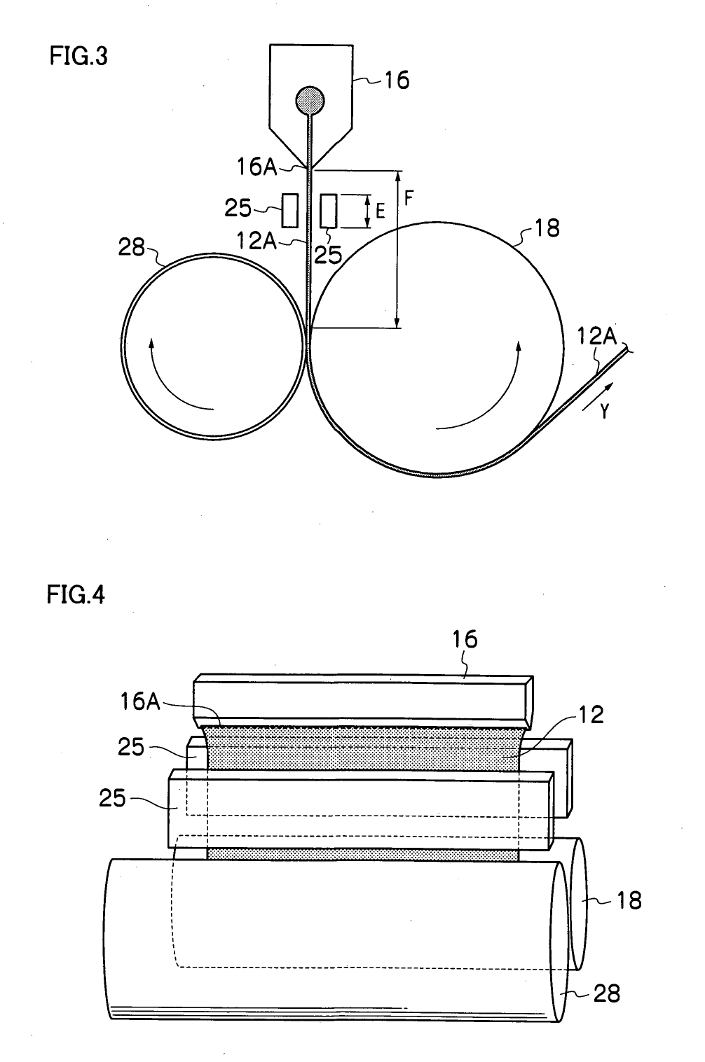

FIG. 3 is a schematic view of the configuration from the die 16 to the casting roll 18 and the touch roll 28, and FIG. 4 is a perspective view of the configuration from the die 16 to the casting roll 18 and the touch roll 28. In the present invention, the resin from the discharge opening 16A of the die 16 to the nip portion between the casting roll 18 and the touch roll 28 is heated with a heating apparatus. In FIGS. 3 and 4, heater heating units 25 are used for heating. Here, the width of the heater heating unit 25 is 1.0 time or more the width of the discharge opening 16A of the die 16, preferably 1.2 times or more that, and as the upper limit preferably the roll length of the casting rolls 18. And, when the length of the heater heating unit 25 in the flow direction of the film 12A (the distance from the top to the bottom of the heater heating unit 25) is E, and the length from the die 16 to the nip portion is F, E/F is preferably 20% or more.

In addition, the length F from the die 16 to the nip portion is preferably 200 mm or less. Setting the length F from the die 16 to the nip portion at 200 mm or less makes it easy to control temperature in the transverse direction and the flow direction, allowing the development of thickness variations of the film produced to be reduced. However, here, the length F from the die 16 to the nip portion is preferably 200 mm or less, more preferably 150 mm or less, and much more preferably 100 mm or less.

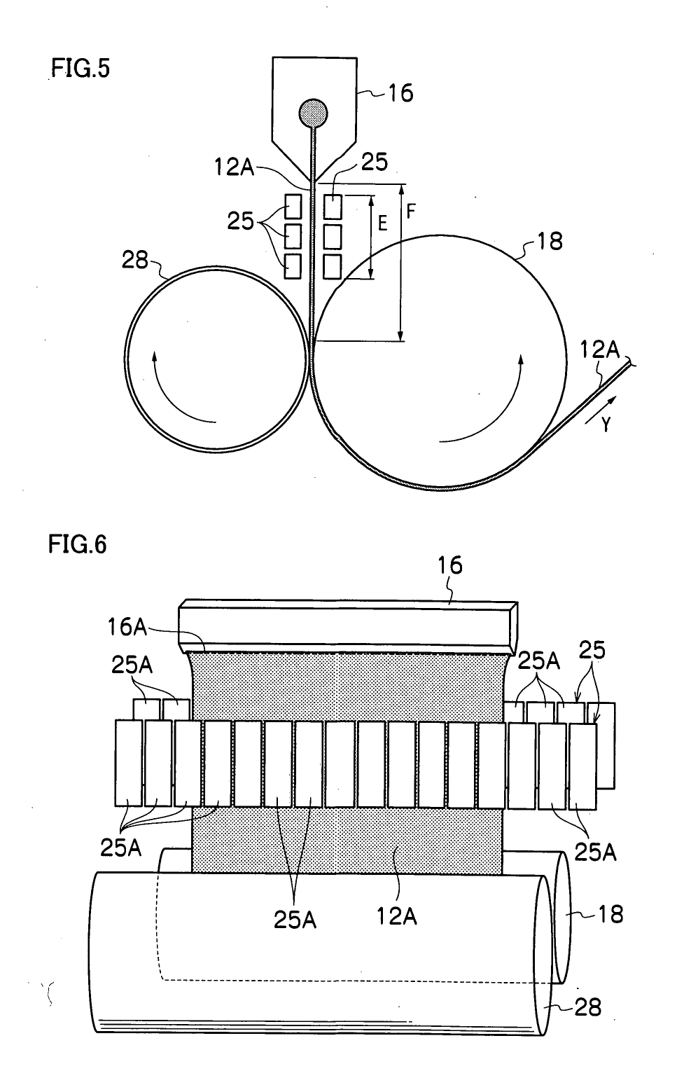

In addition, FIG. 5 illustrates another embodiment of the production process of the present invention, where a plurality of heater heating units 25 are provided in the flow direction of the molten resin. This provision can easily ensure that E/F is 20% or more where E is the length of the heater heating units 25, 25, . . . in the flow direction to the film 12A (the distance from the top to the bottom of the heater heating units 25), and F is the length from the die 16 to the nip portion. Here, E/F is preferably 20% or more, more preferably 50% or more, and much more preferably 70% or more.

In addition, if the heater heating units 25 are heaters 25A, 25A, . . . arranged in the transverse direction as shown in FIG. 6, the heating temperature for the film 12A in the transverse direction can be controlled. The arrangement of the heater heating units 25 in this way so that the heating temperature for the film 12A in the transverse direction can be controlled can further reduce thickness variations in the transverse direction.

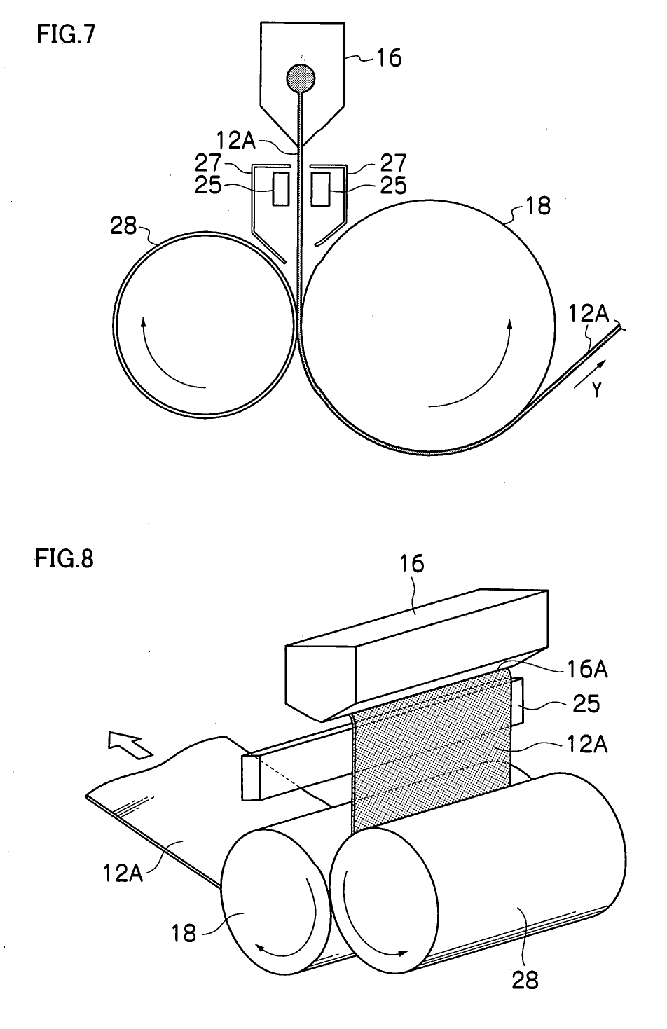

Moreover, as shown in FIG. 7, it can also be considered that the film 12A and the heater heating units 25 are covered with a shielding member 27 having a thermal insulation function and/or a heat reflection function. Covering the film 12A from the die 16 to the point where the resin comes in contact with the casting roll 18 and the heater heating units 25 with a shielding member 27 having a thermal insulation function and/or a heat reflection function in this way can heat the film effectively, ensure the viscosity of the molten resin at the bank portion, cause retardation to develop in the in-plane direction, and reduce thickness variations.

In addition, in the present invention, as shown in FIG. 8, the film 12A can also be heated by providing a heater heating unit 25 on one side of the film 12A to heat at least one side of the film 12A.

As mentioned above, heating the resin from the die discharge opening to the nip portion between the casting roll and the touch roll can maintain the temperature of the resin discharged from the die. This allows for maintaining the desired viscosity of the resin. And, when the resin is passed between the casting roll 18 and the touch roll 28 from the bank portion by the resin, the resin is passed through the narrow space from the bank portion to the casting roll 18 and the touch roll 28. Sudden narrowing causes different shear stresses between the casting roll 18 side and the touch roll 28 side of the formed film, allowing retardation to develop in the thickness direction of the film.

Because it is difficult to measure the resin temperature of the bank portion, the temperature of the resin 20 mm above the bank portion is specified to impart the desired viscosity to the resin. When the glass transition temperature of a thermoplastic resin is Tg, the temperature of the resin 20 mm above the bank portion is preferably (Tg+50)° C. or more, more preferably (Tg+60)° C. or more, and much more preferably (Tg+70)° C. or more. In addition, the upper limit of the resin temperature is preferably (Tg+160)° C. or less, more preferably (Tg+150)° C. or less, and much more preferably (Tg+140)° C. or less. Because the desired temperature can be obtained at the bank portion by setting the temperature of a thermoplastic resin 20 mm above the bank portion in the range above, retardation can be allowed to develop in the in-plane direction when a pressure is applied by the casting roll 18 and the touch roll 28. If the viscosity is too high, the resin is not deformed during the passage of the resin between the casting rolls 18 and the touch roll 28 and no retardation can be allowed to develop in the in-plane direction. In contrast, even if the viscosity is low, the resin can easily be cut by pressing and shear stress cannot be applied to the resin during the passage of the resin through the casting roll 18 and the touch roll 28, so the resin is not deformed and no retardation can be allowed to develop in the in-plane direction. Specifically, the viscosity at the bank portion is preferably between 100 Pa·s or more and 40,000 Pa·s or less, more preferably between 600 Pa·s or more and 20,000 Pa·s or less, and much more preferably between 1,000 Pa·s or more and 10,000 Pa·s or less.

Next, a method of extruding the melt of a thermoplastic resin from the die 16 in film form, passing the melt between the casting roll 18 and the touch roll 28, and cooling and solidifying the melt will be described below. The surfaces of the casting roll 18 and the touch roll 28 each have an arithmetic mean height Ra of usually 100 nm or less, preferably 50 nm or less, and much more preferably 25 nm or less.

In the process for producing a thermoplastic resin film of the present invention, a film is prepared by applying a roll pressure of 20 to 500 MPa during the passage of the melt in film form between the casting roll 18 and the touch roll 28. The roll pressure is preferably 30 to 400 MPa, more preferably 40 to 300 MPa, and much more preferably 50 to 200 MPa. As mentioned above, increasing the roll pressure can apply shear stresses different from each other onto the front surface side and the back surface side of the film formed, allowing retardation to develop in the in-plane direction.

In addition, because the conventional art, for example Japanese Patent Application Laid-Open No. 2003-25414, uses a metal roll and an elastic roll having a low hardness (e.g., a rubber roll coated with a metal described in Japanese Patent Application Laid-Open No. 2003-25414), a high pressure of 20 MPa or more deforms the rubber roll and thus increases the contact area with the melt, failing to apply such a high pressure.

So, to achieve this high roll pressure, the Shore hardness of the roll is preferably 45 HS or more, more preferably 50 HS or more, and much more preferably 60 HS or more.

The Shore hardness can be determined by the method described in JIS Z 2246, from the mean of the values measured at five points in the transverse direction of the roll and five points in the circumferential direction of the roll.

To achieve the Shore hardness, the material of the two rolls is preferably metal and more preferably stainless steel, and a roll whose surface is plated is also preferable. In contrast, a rubber roll and a metal roll lined with rubber have a surface having great irregularities which easily scratch the film surface, so the use thereof is preferably avoided.

Examples of the touch roll that can be used include the rolls described in Japanese Patent Application Laid-Open No. 11-314263, Japanese Patent Application Laid-Open No. 2002-36332, Japanese Patent Application Laid-Open No. 11-235747, International Publication No. WO 97/28950, Japanese Patent Application Laid-Open No. 2004-216717, and Japanese Patent Application Laid-Open No. 2003-145609.

Moreover, the peripheral speed ratio between two rolls between which the melt in film form is passed is adjusted to impart shear stress to the molten resin passing between the two rolls to produce an optical film. The peripheral speed ratio is preferably 0.6 to 0.99 and more preferably 0.75 to 0.98. Here, the peripheral speed ratio between two rolls refers to the peripheral speed of the slower roll divided by the peripheral speed of the faster roll.

The greater the peripheral speed ratio between two rolls is, the greater the absolute value of the difference between Re(40°) and Re(−40°) of the resulting film is. In contrast, a too large difference in peripheral speed provides the resulting film with a surface susceptible to scratches. A peripheral speed ratio between two rolls in the range above provides the film with a surface unsusceptible to scratches and allows a film having good smoothness to be produced stably.

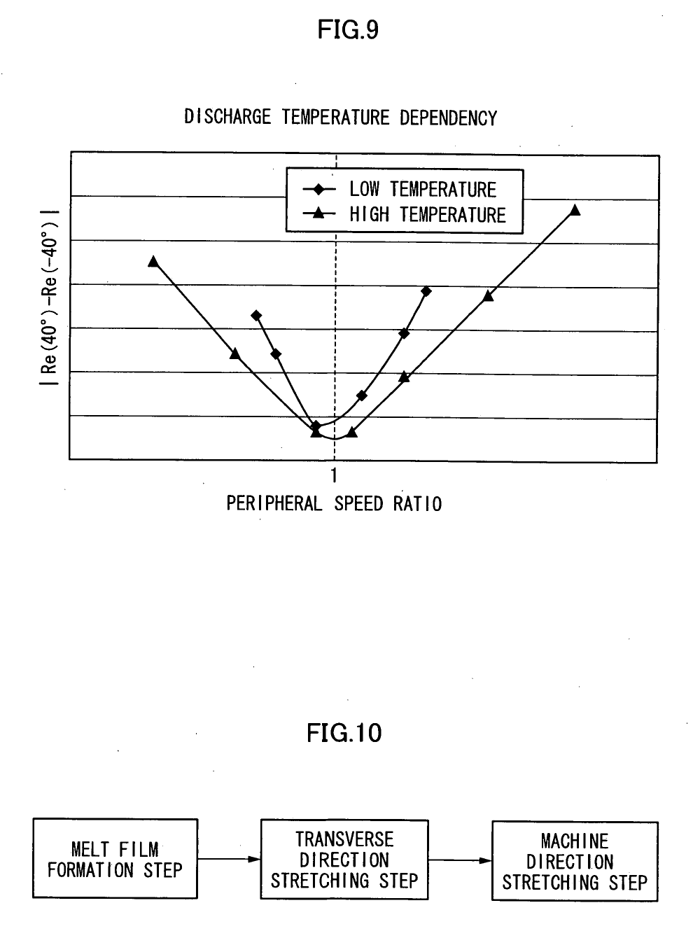

In addition, FIG. 9 shows the relationship between the peripheral speed ratio between two rolls and |Re(40°)−Re(−40°)| assuming that an index ellipsoid is uniformly inclined, at high and low resin temperatures. As shown in FIG. 9, changes in |Re(40°)−Re(−40°)| can be reduced more by changes in peripheral speed ratio at high resin temperature than at low resin temperature, so high resin temperature allows for film production where |Re(40°)−Re(−40°)| is stable.

To obtain the desired film, either of the two rolls may be the faster, and if the touch roll 28 is slow, a bank is formed on the touch roll 28 side. Because the touch roll 28 is in contact with the melt for a short time, the bank formed on the touch roll side cannot be cooled sufficiently, easily causing surface defects. Therefore, preferably, the slower roll is the casting roll 18 and the faster roll is the touch roll 28.

Moreover, a roll having a large diameter is preferably used, and specifically, two rolls having a diameter of preferably 350 to 600 mm and more preferably 350 to 500 mm are used. The use of rolls having a larger diameter provides a greater contact area at which the melt in film form and the rolls are in contact with each other and a longer time required for shearing, allowing a film having a greater difference between Re(40°) and Re(−40°) to be produced while variations in the difference are reduced. Here, the diameters of the two rolls may be equal or different.

The two rolls may be driven in unison or independently and is preferably driven independently to reduce variations in the difference. The two rolls are driven at peripheral speeds different from each other as mentioned above, and moreover the two rolls may be allowed to have surface temperatures different from each other to make the difference between Re(40°) and Re(−40°) greater. The difference in temperature is preferably 5° C. to 80° C., more preferably 20° C. to 80° C., and much more preferably 20° C. to 60° C. At the time, when the glass transition temperature of the resin is Tg, the temperatures of the two rolls is set at preferably (Tg−70)° C. to (Tg+20)° C., more preferably (Tg−50)° C. to (Tg+10)° C., and much more preferably (Tg−40)° C. to (Tg+5)° C. This temperature control can be achieved by circulating a temperature-controlled liquid or gas inside the touch roll.

Here, a differential scanning calorimeter (DSC) can be used to determine the glass transition temperature of the resin as follows. The resin is placed in a measuring pan, the temperature of the resin is raised in a nitrogen stream from 30° C. to 300° C. at a rate of 10° C./min (1st run) followed by cooling down to 30° C. at a rate of −10° C./min, and again the temperature is raised from 30° C. to 300° C. at a rate of 10° C./min (2nd run). The temperature at which the baseline starts to deviate from the low temperature side at the 2nd run is defined as the glass transition temperature (Tg).

In addition, the temperature distribution of the melt in film form can be measured with a contact thermometer or a noncontact thermometer.

A method of reducing variations more is to increase the adhesion when the melt in film form comes in contact with the casting roll. Specifically, the adhesion can be increased by a combination of methods such as an electrostatic application method, an air knife method, an air chamber method, and a vacuum nozzle method. These methods of increasing the adhesion may be performed across the surface of the melt in film form or on part of the surface.

In addition, as shown in FIG. 1, after film formation in that way, the film is preferably cooled with two casting rolls 20 and 22 in addition to the casting roll 18 and the touch roll 28 between which the melt in film form is passed. The casting rolls are usually arranged so that the touch roll comes in contact with the casting roll 18 most upstream (closest to the die). In general, as shown in FIG. 1, three casting rolls are relatively commonly used, but the number of casting rolls is not limited thereto. The surface-to-surface distance between a plurality of casting rolls is preferably 0.3 mm to 300 mm, more preferably 1 mm to 100 mm, and much more preferably 3 mm to 30 mm.

Moreover, both ends of a processed film are preferably trimmed. The portion removed by trimming may be crushed and recycled as a raw material. In addition, one end or both ends are also preferably knurled. The height of raised portions created by knurling is preferably 1 μm to 50 μm and more preferably 3 μm to 20 μm. In knurling, raised portions may be created on both surfaces or on one surface. The width for knurling is preferably 1 mm to 50 mm and more preferably 3 mm to 30 mm. Knurling can be performed at room temperature to 300° C. Before the film is wound, a laminate film is also preferably attached to one surface or both surfaces of the film to be wound. The laminate film has a thickness of preferably 5 μm to 100 μm and more preferably 10 μm to 50 μm. The material thereof may be polyethylene, polyester, polypropylene, or the like, and is not particularly limited.

As shown in FIG. 10, the film 12A produced as mentioned above is preferably stretched in the machine direction and/or the transverse direction, and may also further be shrunk. Especially, stretching in the machine direction followed by stretching in the transverse direction, or a combination of stretching in the transverse direction and shrinking in the machine direction is preferable, and the former is suitable for developing a high Rth whereas the latter is suitable for developing a low Rth.

If stretching in the transverse direction and shrinking in the machine direction are combined, the shrinking in the machine direction may be performed during the stretching in the transverse direction, after the stretching in the transverse direction, or during and after the stretching in the transverse direction. Moreover, stretching in the machine direction may also be performed before or after the stretching in the transverse direction or before and after the stretching in the transverse direction. In addition, after the film 12A is produced in the melt film formation step, the film may also be stretched in the machine direction and the transverse direction without winding the film by a winder 26 temporarily, and then wound. Wind-up tension for winding is preferably 2 kg/m of width to 50 kg/m of width and more preferably 5 kg/m of width to 30 kg/m of width.

In the present invention, the stretching in the machine direction may be performed alone or in combination with the stretching in the transverse direction. The stretching in the machine direction may be performed before or after the stretching in the transverse direction, and more preferably performed before the stretching in the transverse direction. In addition, the stretching in the machine direction may be performed at one stage or at multiple stages.

The stretching in the machine direction can be achieved by installing two pairs of nip rolls, heating between the two pairs, and making the nip rolls on the exit side have a higher peripheral speed than the nip rolls on the inlet side. At the time, the development of retardation in the thickness direction can be changed by changing the gap between the nip rolls (L) and the width of the film before stretching (W). An L/W greater than 2 and 50 or less (long span stretching) can decrease Rth, whereas an L/W between 0.01 or more and 0.3 or less (short span stretching) can increase Rth. In the present invention, any of long span stretching, short span stretching, and in-between stretching (intermediate stretching=an L/W greater than 0.3 and 2 or less) may be used, and long span stretching or short span stretching is preferably because they can decrease the orientation angle. Moreover, more preferably, short span stretching is used for high Rth, and long span stretching is used for low Rth.

These types of stretching in the machine direction have a stretch temperature of preferably (Tg−10)° C. to (Tg+50)° C., more preferably (Tg−5)° C. to (Tg+40)° C., and much more preferably (Tg) to (Tg+30)° C. The stretch ratio is preferably 2% to 200%, more preferably 4% or more and 150% or less, and much more preferably 6% to 100%.

The stretching in the transverse direction can be performed with a tenter. Specifically, the film is clipped at both ends in the transverse direction and made wider in the transverse direction for stretching. At the time, the stretch temperature can be controlled by introducing air at the desired temperature into the tenter. The stretch temperature is preferably between (Tg−10)° C. or more and (Tg+60)° C. or less, more preferably between (Tg−5)° C. or less and (Tg+45)° C. or less, and much more preferably between Tg or more and (Tg+30)° C. or less. The stretch ratio is preferably between 10% or more and 250% or less, more preferably 20% between 200% or less, and much more preferably between 30% or more and 150% or less. As used herein, stretch ratio is defined by the following equation:

Stretch ratio (%)=100×{(length after stretching)−(length before stretching)}/(length before stretching)

### <<Film>>

The film produced by the film production process of the present invention contains a thermoplastic resin and retardation in the thickness direction of the film. Therefore, in the plane containing the longitudinal direction of the film and the film normal line, retardation Re(0°) at a wavelength of 550 nm measured from the normal line, retardation Re(+40°) measured in the direction inclined by +40° with respect to the normal line, and retardation Re(−40°) measured in the direction inclined by −40° with respect to the normal line satisfy the following relations (I) and (II) together:

60 nm≦Re(0°)≦300 nm (I)

40 nm≦|Re(+40°)−Re(−40°)|≦300 nm (II)

As used herein, “the direction inclined by θ° with respect to the normal line” is defined as the direction that is inclined only by θ° from the normal direction to the direction of the film plane with the longitudinal direction of the film as the direction of inclination. In other words, the normal direction of the film plane is the direction having an angle of inclination of 0°, and any direction in the film plane is the direction having an angle of inclination of 90°.

|Re(+40°)−Re(−40°)| of the film is 60 to 250 nm, preferably 60 to 200 nm, more preferably 80 to 180 nm. In addition, in-plane retardation Re(0° is preferably 20 to 200 nm, more preferably 40 to 180 nm, and much more preferably 60 to 160 nm. Moreover, retardation Rth in the thickness direction is preferably 40 to 500 nm, more preferably 40 to 350 nm, and much more preferably 40 to 300 nm.

The use of an optical film having characteristics in the ranges above for optical compensation of liquid crystal displays in TN mode, ECB mode, OCB mode, or the like contributes to improvement in viewing angle characteristics and can achieve a wider viewing angle.

The thickness of the optical film produced by the production process of the present invention is not particularly limited, and if the film is used for liquid crystal displays and the like, the thickness is preferably between 20 μm or more and 100 μm or less, more preferably between 30 μm or more and 80 μm or less, and much more preferably between 40 μm or more and 60 μm or less. According to the production process of the present invention, such a thin film can be produced, and further, retardation can be allowed to develop in the thickness direction when the resin is discharged the resin from the die, cooled and solidified, and formed into a film.

When the film is used in liquid crystal displays, variations in Re(0°), Re(40°), and Re(−40°) result in display variations, so smaller variations therein are more preferable. Specifically, the variations are preferably within ±3 nm and more preferably within ±1 nm. In addition, variations in the angle of the slow axis also cause display variations similarly, so smaller variations therein are more preferable. Specifically, the variations are preferably within ±1°, more preferably within ±0.5°, and much more preferably within ±0.25°. Here, the direction of the slow axis of the film depends on the process for producing the present film described later. For example, when a resin having a positive intrinsic birefringence is passed between two rolls, the direction of the slow axis is the same as the longitudinal direction of the film.

The optical characteristics above can be measured by the following method:

KOBRA-21ADH or -WR (Oji Scientific Instruments Co., Ltd.) is used to measure Re(0°), Re(40°), and Re(−40°) of the film by measuring phase differences at angles of inclination of 40 degrees and −40 degrees with the longitudinal direction as the direction of inclination, in the plane containing the longitudinal direction of the film and the normal line of the film. Here, the measurement wavelength is 550 nm. In the film produced from a general thermoplastic resin by melt film formation, |Re(40°)−Re(−40°)| is nearly equal to 0 nm. In other words, when |Re(40°)−Re(−40°)| is measured with the longitudinal direction as the direction of inclination, a phase difference of 0 nm or more can be allowed to develop.

In addition, variations in Re(0°), Re(40°), and Re(−40°) can be measured by the following method. After sampling is performed at 10 points in the transverse direction of the film and 10 points in the conveying direction of the film that are at regular intervals, Re(0°), Re(40°), and Re(−40°) are measured by the method above and the difference between the maximum and the minimum can be defined as the variation.

Moreover, variations in the angle of the slow axis can also be determined by making measurements at 10 points in the transverse direction of the film and 10 points in the conveying direction of the film that are at regular intervals and calculating the difference between the maximum and the minimum.

Rth can be determined by assuming that an index ellipsoid is uniformly inclined by β°, numerically calculating refractive indices in the directions of the index ellipsoid, nx, ny, and nz, and substituting these values into Eq. A below:

Rth=((nx+ny)/2−nz)×d Eq. A

In the film of the present invention, ny is the refractive index in the transverse direction of the film. nx is the refractive index in the direction in which the component of the film projected onto the x-axis is greater than the component projected onto the z-axis, and nz is the refractive index in the direction in which the component of the film projected onto the z-axis is greater than the component projected onto the x-axis.

A method of determining nx, ny, and nz is described in a technical document from Oji Scientific Instruments Co., Ltd. and the like (http://www.oji-keisoku.co.jp/products/kobra/kobra.html), and these refractive indices can be calculated, for example from Re(0°), Re(40°), and Re(−40°) values, average refractive index value nₐᵥₑ, and film thickness d by using Eq. B:

$$Re ( θ ) = [ {n}_{x} - \frac{{n}_{y} \times {n}_{z}}{\sqrt{\begin{matrix}{n}_{y} {sin ( {sin}^{- 1} ( \frac{sin ( θ )}{{n}_{ave}} ) - β )}^{2} + \\ {n}_{z} {cos ( {sin}^{- 1} ( \frac{sin ( θ )}{{n}_{ave}} ) - β )}^{2}\end{matrix}}} ] \times \frac{d}{cos ( sin - 1 ( \frac{sin ( θ )}{{n}_{ave}} ) )} \qquad [ Expression 1 ]$$

Here, Re(θ) represents the value of retardation in the direction inclined by an angle of θ with respect to the normal direction. In addition, the β in Eq. B represents the angle of inclination assuming that an index ellipsoid is uniformly inclined, and is used to simply understand the structure of an inclined phase difference film.

In the measurements above, an assumed value of the average refractive index can be found among the values listed in Polymer Handbook (John Wiley & Sons, Inc.) or catalogs of various optical compensation films. In addition, if the average refractive index value is not known, the value can be measured with an Abbe refractometer. The average refractive index values of the major optical compensation films are: cellulose acylate (1.48), cycloolefin polymer (1.52), polycarbonate (1.59), polymethyl methacrylate (1.49), and polystyrene (1.59).

### <<Material for Film>>

The thermoplastic resin used in the present invention is not particularly limited as long as the resin has the optical characteristics above, and if the resin is formed into a film by melt extrusion, a material having good melt extrusion properties is preferably used. In this view, cyclic olefins, cellulose acylates, polycarbonates, polyesters, polyolefins such as clear polyethylene and clear polypropylene, polyarylates, polysulphones, polyethersulfones, maleimide-based copolymers, clear nylons, clear fluororesins, clear phenoxies, polyetherimides, polystyrenes, acrylic copolymers, or styrenic copolymers are preferably selected. The material may contain one of the resins or two or more of the resins that are different from each other. Among these, cellulose acylates, and cyclic olefin resin obtained by addition polymerization, polycarbonates, styrenic copolymers, and acrylic copolymers are preferable.

Especially, cellulose acylates, and cyclic olefin resin obtained by addition polymerization, and polycarbonates that have a positive intrinsic birefringence can be used to produce films having |Re(40°)−Re(−40°)|>0 with the slow axis directed to the MD and with the longitudinal direction as the direction of inclination when these resins are deformed by shear stress due to two rolls.

In addition, acrylic copolymers and styrenic copolymers that have a negative intrinsic birefringence can be used to produce films having |Re(40°)−Re(−40°)|>0 with the slow axis directed to the TD and with the longitudinal direction as the direction of inclination when the resins are processed in the way above.

If the present films are applied to liquid crystal display devices as viewing angle compensation films, a resin can be appropriately selected from the above resins having a positive or negative intrinsic birefringence in view of the characteristics of liquid crystal display devices and the convenience of polarizing plate processing.

Examples of the cyclic olefin copolymers that can be used in the present invention include a resin obtained by polymerizing a norbornene compound. This resin may be a resin obtained by any polymerization process of ring-opening polymerization and addition polymerization.

Examples of addition polymerization and resins obtained thereby include those described in Japanese Patent No. 3517471, Japanese Patent No. 3559360, Japanese Patent No. 3867178, Japanese Patent No. 3871721, Japanese Patent No. 3907908, Japanese Patent No. 3945598, National Publication of International Patent Application No. 2005-527696, Japanese Patent Application Laid-Open No. 2006-28993, Japanese Patent Application Laid-Open No. 2006-11361, International Publication No. WO 2006/004376, and International Publication No. WO 2006/030797. Among these, those described in Japanese Patent No. 3517471 are particularly preferable.

Examples of ring-opening polymerization and resins obtained thereby include those described in International Publication No. WO 98/14499, Japanese Patent No. 3060532, Japanese Patent No. 3220478, Japanese Patent No. 3273046, Japanese Patent No. 3404027, Japanese Patent No. 3428176, Japanese Patent No. 3687231, Japanese Patent No. 3873934, and Japanese Patent No. 3912159. Among these, those described in International Publication No. WO 98/14499 and Japanese Patent No. 3060532 are particularly preferable.

Among these cyclic olefins, those obtained by addition polymerization are preferable in view of development of birefringence and melt viscosity, and for example TOPAS 6013 (Polyplastics Co., Ltd.) can be used.

Examples of the cellulose acylates that can be used in the present invention include any cellulose acrylate where at least a part of three hydroxy groups in the cellulose unit is substituted with an acyl group. The acyl group (preferably having 3 to 22 carbon atoms) may be any of an aliphatic acyl group and an aromatic acyl group. Among these, a cellulose acrylate having an aliphatic acyl group is preferable, a cellulose acrylate having an aliphatic acyl group and 3 to 7 carbon atoms is more preferable, a cellulose acrylate having an aliphatic acyl group and 3 to 6 carbon atoms is much more preferable, and a cellulose acrylate having an aliphatic acyl group and 3 to 5 carbon atoms is still more preferable. A plurality of species of these acyl groups may be present in a molecule. Examples of preferable acyl groups include an acetyl group, a propionyl group, a butyryl group, a pentanoyl group, and a hexanoyl group. Among these, a cellulose acrylate having one or two or more selected from an acetyl group, a propionyl group, and a butyryl group is more preferable, and a cellulose acrylate having both an acetyl group and a propionyl group (CAP) is much more preferably. CAP is preferable in terms of ease of resin synthesis and a high stability of extrusion.

If an optical film is produced by melt extrusion such as the process of the present invention, the cellulose acrylate used preferably satisfies Ineqs. S-1 and S-2 below. The cellulose acrylate satisfying the Inequalities below has a low melting temperature, or improved meltability, and thus excellent film formability by melt extrusion.

2.0≦X+Y≦3.0 Ineq. S-1

0.25≦Y≦3.0 Ineq. S-2

where X represents the degree of substitution of the hydroxy group with the acetyl group in cellulose, and Y represents the sum of the degrees of substitution of the hydroxy group with the acetyl group in cellulose. As used herein, the “degree of substitution” refers to the total of the extent to which the hydrogen atom of each of the hydroxy groups in positions 2, 3, and 6 is substituted in cellulose. If the hydrogen atoms of all the hydroxy groups in positions 2, 3, and 6 are substituted with acyl groups, the degree of substitution is 3.

Moreover, a cellulose acrylate satisfying the Inequalities below is more preferably used:

2.3≦X+Y≦2.95

1.0≦Y≦2.95

A cellulose acrylate satisfying the Inequalities below is much more preferably used:

2.7≦X+Y≦2.95

2.0≦Y≦2.9

The mass-average degree of polymerization and number-average molecular weight of cellulose acylates are not particularly limited. In general, the mass-average degree of polymerization is about 350 to 800, and the number-average molecular weight is about 70,000 to 230,000. The cellulose acylates can be synthesized by using an acid anhydride or an acid chloride as an acylating agent. In the synthesis process that is the most common industrially, cellulose obtained from cotton linters, wood pulp, or the like is esterified with a mixed organic acid component containing an organic acid (acetic acid, propionic acid, or butyric acid) or an acid anhydride thereof (acetic anhydride, propionic anhydride, or butyric anhydride) corresponding to acetyl groups and other acyl groups, to synthesize a cellulose ester. As a process for synthesizing a cellulose acrylate satisfying Ineqs. S-1 and S-2, the process described on pages 7 to 12 in the JIII Journal of Technical Disclosure (Technical Disclosure No. 2001-1745; published on Mar. 15, 2001, Japan Institute of Invention and Innovation) as well as the processes described in Japanese Patent Application Laid-Open No. 2006-45500, Japanese Patent Application Laid-Open No. 2006-241433, Japanese Patent Application Laid-Open No. 2007-138141, Japanese Patent Application Laid-Open No. 2001-188128, Japanese Patent Application Laid-Open No. 2006-142800, and Japanese Patent Application Laid-Open No. 2007-98917 can be referred to.

Examples of the polycarbonates that can be used in the present invention include a polycarbonate resin having the bisphenol A skeleton, which is obtained by reacting the dihydroxy component with a carbonate precursor by interfacial polymerization or melt polymerization. For example, those described in Japanese Patent Application Laid-Open No. 2006-277914 and Japanese Patent Application Laid-Open No. 2006-106386, and Japanese Patent Application Laid-Open No. 2006-284703 can be preferably used. For example, the commercially available product TARFLON MD1500 (Idemitsu Kosan Co., Ltd.) can be used.

Examples of the styrenic copolymers that can be used in the present invention include a styrene-acrylonitrile resin, a styrene-acrylic resin, and multicomponent (e.g., binary, ternary) copolymers thereof. Among these, a styrene-maleic anhydride resin is preferable in view of film strength.

In the styrene-maleic anhydride resin, the composition ratio by mass of styrene to maleic anhydride, styrene:maleic anhydride, preferably ranges from 95:5 to 50:50 and more preferably from 90:10 to 70:30. In addition, to adjust the intrinsic birefringence, a styrenic resin can preferably be hydrogenated.

Examples of the styrene-maleic anhydride resin include DYLARK 332 from NOVA Chemicals, Inc.

The acrylic copolymer of the present invention is resins obtained by polymerizing styrene and acrylic acid, methacrylic acid, and derivatives thereof, and derivatives of the resins, and is not particular limited as long as the copolymer does not reduce the advantages of the present invention. Among the resins, a resin containing 30 mol % or more of MMA units (monomers) of all monomers making up the resin is preferable, and a resin containing at least one of lactone ring units, maleic anhydride units, and glutaric anhydride units in addition to MMA is more preferable. For example, the following can be used.

(1) Acrylic Resins Containing Lactone Ring Units

The resins described in Japanese Patent Application Laid-Open No. 2007-297615, Japanese Patent Application Laid-Open No. 2007-63541, Japanese Patent Application Laid-Open No. 2007-70607, Japanese Patent Application Laid-Open No. 2007-100044, Japanese Patent Application Laid-Open No. 2007-254726, Japanese Patent Application Laid-Open No. 2007-254727, Japanese Patent Application Laid-Open No. 2007-261265, Japanese Patent Application Laid-Open No. 2007-293272, Japanese Patent Application Laid-Open No. 2007-297619, Japanese Patent Application Laid-Open No. 2007-316366, Japanese Patent Application Laid-Open No. 2008-9378, Japanese Patent Application Laid-Open No. 2008-76764, and the like can be used. Among these, the resin described in Japanese Patent Application Laid-Open No. 2008-9378 is more preferable.

(2) Acrylic Resins Containing Maleic Anhydride Units

The resins described in Japanese Patent Application Laid-Open No. 2007-113109, Japanese Patent Application Laid-Open No. 2003-292714, Japanese Patent Application Laid-Open No. 6-279546, Japanese Patent Application Laid-Open No. 2007-51233 (acid-modified vinyl described in this reference), Japanese Patent Application Laid-Open No. 2001-270905, Japanese Patent Application Laid-Open No. 2002-167694, Japanese Patent Application Laid-Open No. 2000-302988, Japanese Patent Application Laid-Open No. 2007-113110, Japanese Patent Application Laid-Open No. 2007-11565 can be used. Among these, the resin described in Japanese Patent Application Laid-Open No, 2007-113109 is more preferably. In addition, commercially available maleic acid-modified MAS resins (e.g., Delpet 980N from Asahi Kasei Chemicals Corporation) can also preferably be used.

(3) Acrylic Resins Containing Glutaric Anhydride Units

The resins described in Japanese Patent Application Laid-Open No. 2006-241263, Japanese Patent Application Laid-Open No, 2004-70290, Japanese Patent Application Laid-Open No. 2004-70296, Japanese Patent Application Laid-Open No. 2004-126546, Japanese Patent Application Laid-Open No. 2004-163924, Japanese Patent Application Laid-Open No. 2004-291302, Japanese Patent Application Laid-Open No. 2004-292812, Japanese Patent Application Laid-Open No. 2005-314534, Japanese Patent Application Laid-Open No. 2005-326613, Japanese Patent Application Laid-Open No. 2005-331728, Japanese Patent Application Laid-Open No. 2006-131898, Japanese Patent Application Laid-Open No. 2006-134872, Japanese Patent Application Laid-Open No. 2006-206881, Japanese Patent Application Laid-Open No. 2006-241197, Japanese Patent Application Laid-Open No. 2006-283013, Japanese Patent Application Laid-Open No. 2007-118266, Japanese Patent Application Laid-Open No. 2007-176982, Japanese Patent Application Laid-Open No. 2007-178504, Japanese Patent Application Laid-Open No. 2007-197703, Japanese Patent Application Laid-Open No. 2008-74918, WO 2005/105918, and the like can be used. Among these, the resin described in Japanese Patent Application Laid-Open No. 2008-74918 is more preferable.

The glass transition temperature (Tg) of these resins is preferably between 106° C. or more and 170° C. or less, more preferably between 110° C. or more and 160° C. or less, and much more preferably between 115° C. or more and 150° C. or less. The commercially available product Delpet 980N (Asahi Kasei Chemicals Corporation) can be used.

The optical film of the present invention may contain materials other than the thermoplastic resins above, and preferably contains one or two or more of the thermoplastic resins as the main component(s) (referring to the material having the highest content of all the materials in the composition; for an aspect containing two or more of the resins, referring to the two or more the total content of which is higher than the content of each of the other materials). Materials other than the thermoplastic resins include various additives, and examples thereof include stabilizers, ultraviolet absorbers, light stabilizers, plasticizers, fine particles, and optical adjusters.

(i) Stabilizers

The optical film of the present invention may contain at least one stabilizer. A stabilizer is preferably added before or when the thermoplastic resin is heated and melted. Stabilizers act, for example, to prevent the oxidation of film constituent materials, trap an acid generated by degradation, and reduce or prevent the degradation reaction due to radical species produced by light or heat. Stabilizers are useful for reducing the induction of alterations such as coloration and molecular weight loss, the production of volatile components, and the like by various degradation reactions including poorly understood degradation reactions. Stabilizers themselves are required to function without degrading even at the melt temperature at which a resin is formed into a film. Typical examples of the stabilizers include phenolic stabilizers, phosphite stabilizers, thioether stabilizers, amine stabilizers, epoxy stabilizers, lactone stabilizers, amine stabilizers, and metal deactivators (tin stabilizers). These are described, for example, in Japanese Patent Application Laid-Open No. 3-199201, Japanese Patent Application Laid-Open No. 5-1907073, Japanese Patent Application Laid-Open No. 5-194789, Japanese Patent Application Laid-Open No. 5-271471, Japanese Patent Application Laid-Open No. 6-107854, and in the present invention, at least one or more of phenolic stabilizers and phosphite stabilizers are preferably used. Among the phenolic stabilizers, especially a phenolic stabilizer having a molecular weight of 500 or more is preferably added. Examples of preferable phenolic stabilizers include hindered phenol stabilizers.

These materials are readily commercially available and sold by the following manufacturers. The materials are available from Ciba Japan K.K. under the trade names Irganox 1076, Irganox 1010, Irganox 3113, Irganox 245, Irganox 1135, Irganox 1330, Irganox 259, Irganox 565, Irganox 1035, Irganox 1098, and Irganox 1425WL. In addition, they are available from ADEKA Corporation under the trade names ADK STAB AO-50, ADK STAB AO-60, ADK STAB AO-20, ADK STAB AO-70, and ADK STAB AO-80. Moreover, they are available from Sumitomo Chemical Co., Ltd. under the trade names Sumilizer BP-76, Sumilizer BP-101, Sumilizer GA-80. In addition, they are available from Shipro Kasei Kaisha, Ltd. under the trade names Seenox 326M and Seenox 336B.

In addition, as the phosphite stabilizers, the compounds described in [0023] to [0039] in Japanese Patent Application Laid-Open No. 2004-182979 can more preferably be used. Examples of the phosphorous acid stabilizers include the compounds described in Japanese Patent Application Laid-Open No. 51-70316, Japanese Patent Application Laid-Open No. 10-306175, Japanese Patent Application Laid-Open No. 57-78431, Japanese Patent Application Laid-Open No. 54-157159, and Japanese Patent Application Laid-Open No. 55-13765. Moreover, as other stabilizers, the materials described in detail on pages 17 to 22 in the JIII Journal of Technical Disclosure (Technical Disclosure No. 2001-1745, published on Mar. 15, 2001; Japan Institute of Invention and Innovation) can preferably be used.

Among the phosphite stabilizers, phosphite stabilizers having a high molecular weight are useful in order to maintain their stability at high temperature, and have a high molecular weight of preferably 500 or more, more preferably 550 or more, and much more preferably 600 or more. Moreover, at least one substituent is preferably an aromatic ester group. In addition, the phosphite stabilizers are preferably triesters, and desirably do not contain impurities such as phosphoric acid, monoesters, and diesters. If these impurities are present, the content is preferably 5% by mass or less, more preferably 3% by mass or less, and much more preferably 2% by mass or less. Examples of these stabilizers include the compounds described in [0023] to [0039] in Japanese Patent Application Laid-Open No. 2004-182979 as well as the compounds described in Japanese Patent Application Laid-Open No. 51-70316, Japanese Patent Application Laid-Open No. 10-306175, Japanese Patent Application Laid-Open No. 57-78431, Japanese Patent Application Laid-Open No. 54-157159, and Japanese Patent Application Laid-Open No. 55-13765. Preferable examples of the phosphite stabilizers include the following compounds, but the phosphite stabilizers that can be used in the present invention are not limited thereto.

These are commercially available from ADEKA Corporation under the trade names ADK STAB 1178, ADK STAB 2112, ADK STAB PEP-8, ADK STAB PEP-24G, ADK STAB PEP-36G, and ADK STAB HP-10, and from Clariant (Japan) K.K. under the trade name Sandostab P-EPQ. Furthermore, stabilizers having phenol and phosphite in the same molecule are also preferably used. These compounds are described in more detail in Japanese Patent Application Laid-Open No. 10-273494, and examples thereof are included in the examples of the stabilizers mentioned above but not limited to the examples. A typical commercially available product thereof is Sumilizer GP from Sumitomo Chemical Co., Ltd. These stabilizers are commercially available from Sumitomo Chemical Co., Ltd. under the trade names Sumilizer TPL, Sumilizer TPM, Sumilizer TPS, and Sumilizer TDP. They are also commercially available from ADEKA Corporation under the trade name ADK STAB AO-412S.

The stabilizers can be used alone or in combination of two or more, and the content thereof is appropriately selected in a range that does not compromise the object of the present invention. The amount of stabilizer(s) added is preferably 0.001 to 5% by mass, more preferably 0.005 to 3% by mass, and much more preferably 0.01 to 0.8% by mass with respect to the mass of the thermoplastic resin.

(ii) Ultraviolet Absorbers

The optical film of the present invention may contain one or two or more ultraviolet absorbers. Preferably, the ultraviolet absorbers have an excellent capacity to absorb ultraviolet light having a wavelength of 380 nm or less in view of degradation prevention and they poorly absorb visible light having a wavelength of 400 nm or more in view of clarity. Examples thereof include oxybenzophenone compounds, benzotriazoles compounds, salicylate compounds, benzophenone compounds, cyanoacrylate compounds, and nickel complex salt compounds. Particularly preferable ultraviolet absorbers are benzotriazoles compounds and benzophenone compounds. Among these, benzotriazoles compounds are preferable because the compounds hardly color cellulose mixed esters more than necessary. These are described in Japanese Patent Application Laid-Open No. 60-235852, Japanese Patent Application Laid-Open Nos. 3-199201, 5-1907073, 5-194789, 5-271471, 6-107854, 6-118233, 6-148430, 7-11056, 7-11055, 7-11056, 8-29619, 8-239509, and Japanese Patent Application Laid-Open No. 2000-204173.

The amount of ultraviolet absorber(s) added is preferably 0.01 to 2% by mass and more preferably 0.01 to 1.5% by mass with respect to the thermoplastic resin.

(iii) Light Stabilizers

The optical film of the present invention may contain one or two or more light stabilizers. Examples of the light stabilizers include hindered amine light stabilizer (HALS) compounds, and more specifically include 2,2,6,6-tetraalkylpiperidine compounds or acid addition salts thereof or complexes of the compounds and metal compounds as described in columns 5 to 11 of the specification of U.S. Pat. No. 4,619,956 and in columns 3 to 5 of the specification of U.S. Pat. No. 4,839,405. These are commercially available from ADEKA Corporation under the trade names ADK STAB LA-57, ADK STAB LA-52, ADK STAB LA-67, ADK STAB LA-62, and ADK STAB LA-77, and from Ciba Japan K.K. under the trade names TINUVIN 765 and TINUVIN 144.

These hindered amine light stabilizers can be used alone or in combination of two or more. In addition, these hindered amine light stabilizers may naturally be used with additives such as plasticizers, stabilizers, and ultraviolet absorbers, or introduced into part of molecular structure of these additives. The content thereof is determined in a range that does not reduce the advantages of the present invention, and generally about 0.01 to 20 parts by mass with respect to 100 parts by mass of the thermoplastic resin, preferably about 0.02 to 15 parts by mass, more preferably about 0.05 to 10 parts by mass. Light stabilizers may be added at any stage during the preparation of melt of a thermoplastic resin composition, for example at the end of the melt preparation step.

(iv) Plasticizers

The optical film of the present invention may contain a plasticizer. A plasticizer is preferably added in view of film modifications such as improved mechanical characteristics, imparted flexibility, imparted water absorption resistance, and reduced moisture permeability. In addition, if the optical film of the present invention is produced by melt film formation, a plasticizer will be added in order to make the melt temperature of the film constituent materials lower than the glass transition temperature of the thermoplastic resin used or to make the viscosity lower than a thermoplastic resin without any plasticizer at the same heating temperature. For example, a plasticizer selected from phosphate derivative and carboxylate derivatives is preferably used for the optical film of the present invention. In addition, the polymer having a weight-average molecular weight between 500 or more and 10,000 or less obtained by polymerizing an unsaturated ethylene monomer, the acrylic polymer, the acrylic polymer having an aromatic ring in the side chain, or the acrylic polymer having a cyclohexyl group in the side chain, and the like that are described in Japanese Patent Application Laid-Open No. 2003-12859 are also preferably used.

(v) Fine Particles

The optical film of the present invention may contain fine particles. Examples of the fine particles include fine particles of inorganic compounds and fine particles of organic compounds, either of which can be used. The fine particles contained in a thermoplastic resin in the present invention have an average primary particle size of preferably 5 nm to 3 μm, more preferably 5 nm to 2.5 μm, and much more preferably 10 nm to 2.0 μm in view of making the haze low. Here, the average primary particle size of fine particles is determined by observing a thermoplastic resin under a transmission electron microscope (magnification, 500,000 to 1,000,000) and calculating the average primary particle size of 100 particles. The amount of fine particles added is preferably 0.005 to 1.0% by mass with respect to a thermoplastic resin, more preferably 0.01 to 0.8% by mass, and much more preferably 0.02 to 0.4% by mass.

(vi) Optical Adjusters

The optical film of the present invention may contain an optical adjuster. An optical adjuster is retardation adjusters, and examples thereof include the adjusters described in Japanese Patent Application Laid-Open No. 2001-166144, Japanese Patent Application Laid-Open No. 2003-344655, Japanese Patent Application Laid-Open No. 2003-248117, and Japanese Patent Application Laid-Open No. 2003-66230. Addition of an optical adjuster can control retardation (Re) in the in-plane direction and retardation (Rth) in the thickness direction. The amount added is preferably 0 to 10% by mass, more preferably 0 to 8% by mass, and much more preferably 0 to 6% by mass.

### EXAMPLES

The features of the present invention will be described below more specifically by referring to Examples and Comparative Examples. The materials, amounts used thereof, rates/ratios, treatment details, treatment procedures, and the like shown in the Examples below can be appropriately changed as long as they do not deviate from the gist of the present invention. Therefore, the scope of the present invention should not be construed as limited by the specific examples below.

### Example 1

In the melt film formation step shown in FIG. 3, the touch roll film formation where a film 12A in the high-temperature molten state discharged from a die 16 is dropped onto the center of the nip point between a casting roll 18 and a touch roll 28 that use the touch roll process was used. The air gap (molten resin film) between the casting roll 18 and the touch roll 28 was heated with heater heating units 25 to test how the condition of the surface of the film 12A produced was improved.

Here, the touch roll 28 refers to the roll, the contact length of which with the film 12 is the shorter, and the casting roll 18 refers to the roll, the contact length of which with the film 12 is the longer, in touch roll film formation.

The film 12A was given a film thickness of 60 μm and a width of 1,500 mm after the ends were slit when the film took its final shape, and as the raw material, a cycloolefin copolymer (hereinafter also referred to as COC) was used. The cycloolefin copolymer has a glass transition temperature Tg of 140° C.

The clearance of the discharge opening of the die 16 was set at 800 μm and the air gap from the discharge opening to the surface of the casting roll 18 was set at 100 mm. The die 16 was given a discharge temperature of 266° C. and a line speed of 12 m/min. In addition, the resin 20 mm above the bank portion had a temperature of 211° C. as measured with a radiation thermometer.

As the touch roll 28, a 0.1-S roll having a diameter of 200 mm and a mirror-finish obtained by HCr plating the material S45C was used. The casting rolls 18, 20, and 22 each had a diameter of 300 mm and were 0.1-S rolls having a mirror-finish obtained by HCr plating the material S45C as was the case with the touch roll.

As the heater heating units, far-infrared heaters were used. The heater width was 1.2 times the die lip width, and the heater heating distance was 70% of the length F from the die 16 to the nip portion.

In addition, the surface temperature of the touch roll 28 and the casting rolls 18, 20, and 22 was set at 130° C. to measure variations in the thickness of the film produced.

### (How to Measure the Thickness)

An off-line contact continuous thickness gauge (Film Thickness Tester KG601B, Anritsu Company) was used to measure the thickness of the film with the measurement pitch set at an interval of 1 mm. The thickness of the film 12A in the transverse direction of the film was measured over the overall width of the film after trimming, and the thickness of the film 12A in the conveying direction of the film was measured over a length of 3 m of the film.

In addition, the casting roil 18 and the touch roll 28 was given a peripheral speed ratio of 1, and the nip pressure was set at 20 MPa. Here, the nip pressure was calculated by compressing Prescale, a pressure measurement film, from FUJIFILM Corporation at a nip point at a roll temperature of 25° C. with molten resin absent at the nip point for color development and then converting the degree of color development into a pressure value by using FPD-305, a densitometer for Prescale, and FPD-306, a pressure reader for Prescale. This value was defined as the nip pressure (roll pressure) during film production.

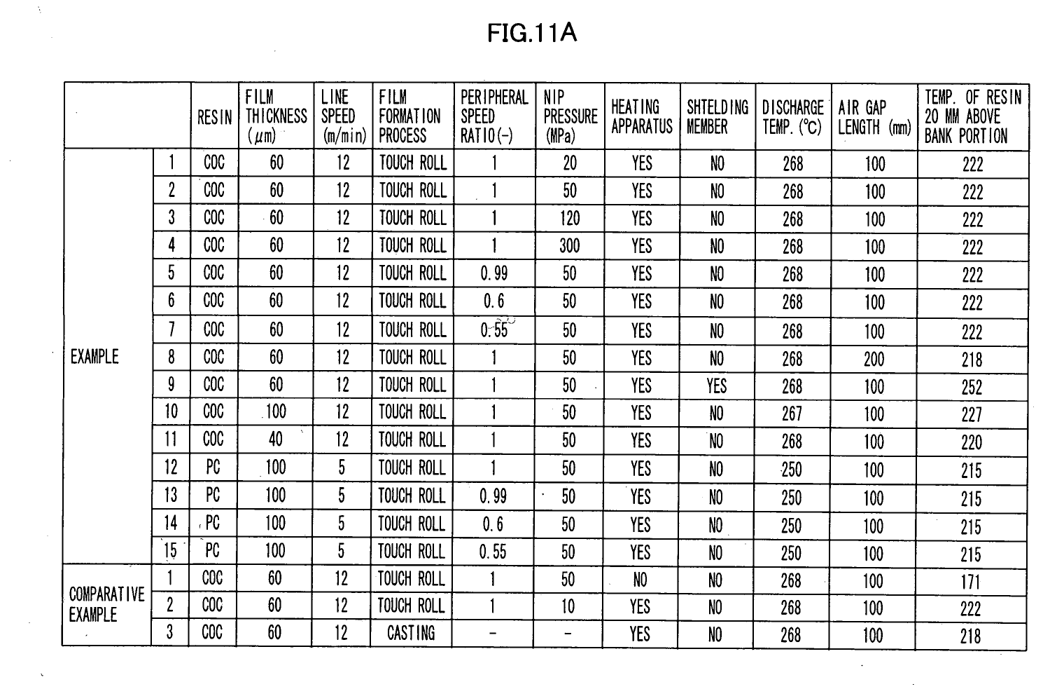

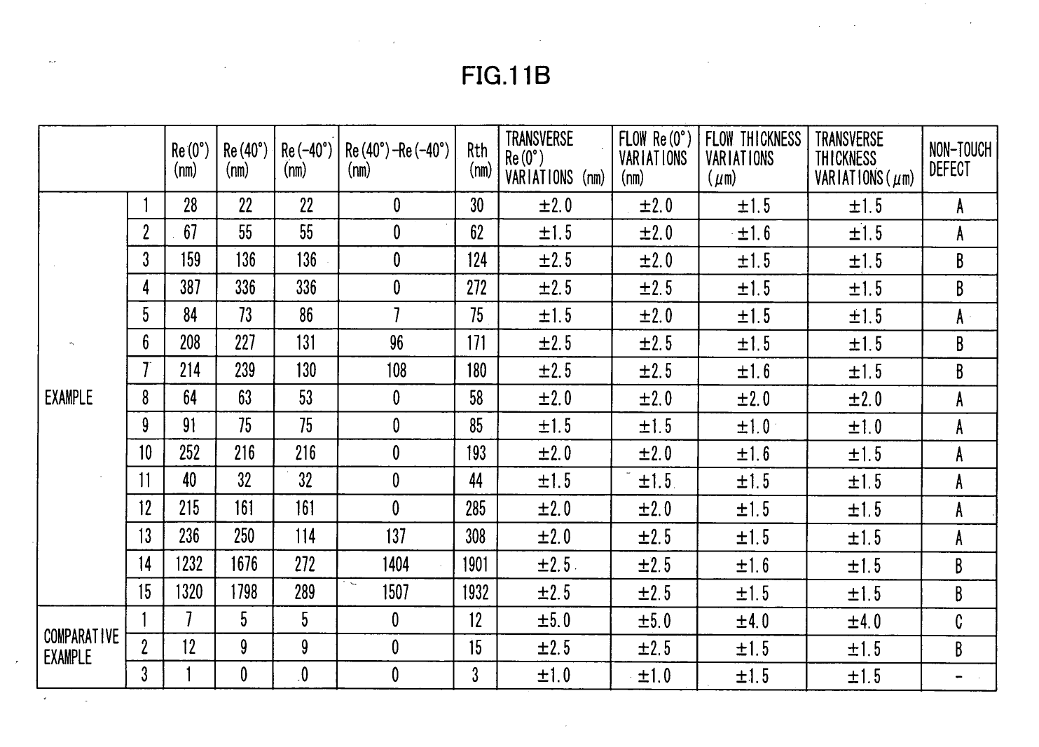

After the film was produced under the conditions above, Re(0°), Re(40°), Re(−40°), transverse Re(0°) variations, flow Re(0°) variations, flow thickness variations, and transverse thickness variations were measured, and the film was visually checked for non-touch defects. A non-touch defect refers to a defect developing in line form along the interface between the region where the film is in contact with the touch roll and the region where the film is not in contact with the touch roll. The non-touch defects were evaluated based on the following criteria. The results are shown in FIGS. 11A and 11B.

A: Non-touch defect area per square meter of the film is less than 0.01%

B: Non-touch defect area per square meter of the film is between 0.01% or more and less than 0.1%

C: Non-touch defect area per square meter of the film is 0.1% or more

### Example 2

The test conditions were the same as in Example 1 except that the nip pressure was set at 50 MPa.

### Example 3

The test conditions were the same as in Example 1 except that the nip pressure was set at 120 MPa.

### Example 4

The test conditions were the same as in Example 1 except that the nip pressure was set at 500 MPa.

### Example 5

The test conditions were the same as in Example 2 except that the touch roll was given a higher peripheral speed to set the peripheral speed ratio of the casting roll to the touch roll at 0.99.

### Example 6

The test conditions were the same as in Example 2 except that the touch roll was given a higher peripheral speed to set the peripheral speed ratio of the casting roll to the touch roll at 0.6.

### Example 7

The test conditions were the same as in Example 2 except that the touch roll was given a higher peripheral speed to set the peripheral speed ratio of the casting roll to the touch roll at 0.55.

### Example 8

The test conditions were the same as in Example 2 except that the air gap from the discharge opening of the die 16 to the surface of the casting roll 18 was set at 200 mm.

### Example 9

The test conditions were the same as in Example 2 except that as shown in FIG. 7, the molten resin and heater heating units 25 were covered with a shielding member 27 composed of aluminum.

### Example 10

The test conditions were the same as in Example 2 except that the average thickness of the film produced was set at 100 μm.

### Example 11

The test conditions were the same as in Example 2 except that the average thickness of the film produced was set at 40 μm.

### Example 12

A polycarbonate (hereinafter also referred to as PC) was used as the raw material. The polycarbonate has a glass transition temperature Tg of 150° C. The film thickness of the film produced was set at 100 μm. The discharge temperature of the die 16 was set at 250° C. and the line speed was set at 5 m/min. Except for these conditions, the test conditions were the same as in Example 2.

### Example 13

The test conditions were the same as in Example 12 except that the touch roll was given a higher peripheral speed to set the peripheral speed ratio of the casting roll to the touch roll at 0.99.

### Example 14

The test conditions were the same as in Example 12 except that the touch roll was given a higher peripheral speed to set the peripheral speed ratio of the casting roll to the touch roll at 0.6.

### Example 15

The test conditions were the same as in Example 12 except that the touch roll was given a higher peripheral speed to set the peripheral speed ratio of the casting roll to the touch roll at 0.55.

### Comparative Example 1

The test conditions were the same as in Example 2 except that no heating apparatus was provided.

### Comparative Example 2

The test conditions were the same as in Example 1 except that the nip pressure was set at 10 MPa.

### Comparative Example 3

The test conditions were the same as in Example 1 except that as the film formation process, the casting process was used instead of the touch roll process.

### EVALUATION

In the films produced by the methods of Examples 1 to 4 where the nip pressure was varied, in-plane retardation having a high value could be allowed to develop. Especially, in Examples 1 to 3 where the nip pressure was in the range of 20 to 120 MPa, good films where transverse Re(0°) variations and flow Re(0°) variations were reduced could be produced when in-plane retardation was in the range between 20 nm or more and 200 nm or less. In addition, retardation in the thickness direction could also be made higher than in Comparative Examples.

In Comparative Example 2 where the nip pressure was low, no retardation developed. Although increased nip pressure tended to cause non-touch defects, a nip pressure of 500 MPa or less did not provide non-touch defects at a level that was not problematic.

Even in Comparative Example 1 where no heating apparatus was used and Comparative Example 3 where the casting process was used, sufficient retardation did not develop, whereas in Comparative Example 1, retardation variations and thickness were great and non-touch defects were also found.

In Examples 5 to 7 where the peripheral speed ratio of the casting roll to the touch roll was varied, a difference in peripheral speed allowed retardation to develop, making |Re(40°)−Re(−40°)| larger, but because of the small amount of the bank, non-touch defects tended to occur. In addition, in Example 8 where the air gap was made longer, Re(0°) variations as well as thickness variations in the transverse direction were great.

Even in Examples 12 to 15 where the type of the resin was polycarbonate, high retardation developed and good films having reduced retardation variations and thickness variations were produced as in Examples 1 to 11 where a cycloolefin copolymer was used.

What is claimed is:

1. A process for producing a thermoplastic resin film, comprising:
a feeding step of feeding a molten resin containing a thermoplastic resin from a feeding device;
a heating step of heating the molten resin from a discharge opening of the feeding device to a nip portion between a first compression surface and a second compression surface that are included in a compression apparatus by using a heating apparatus; and
a film formation step of continuously compressing the heated molten resin between the first compression surface and the second compression surface to form a film, wherein
a pressure applied to the molten resin by the compression apparatus is between 20 MPa or more and 500 MPa or less.

2. The process for producing a thermoplastic resin film according to claim 1, wherein
the resin 20 mm above a bank portion that is the upper side of the nip portion between the first compression surface and the second compression surface has a temperature of (Tg 50)° C. or more where Tg is the glass transition temperature of the thermoplastic resin.

3. The process for producing a thermoplastic resin film according to claim 1, wherein
a travel speed ratio of the second compression surface to the first compression surface of the compression apparatus defined by Eq. 1 below is between 0.6 and 0.99 (both inclusive):
Travel speed ratio=Second compression surface speed/First compression surface speed Eq. 1

4. The process for producing a thermoplastic resin film according to claim 2, wherein
a travel speed ratio of the second compression surface to the first compression surface of the compression apparatus defined by Eq. 1 below is between 0.6 and 0.99 (both inclusive):
Travel speed ratio=Second compression surface speed/First compression surface speed Eq. 1

5. The process for producing a thermoplastic resin film according to claim 1, wherein the first compression surface and the second compression surface of the compression apparatus are two rolls.

6. The process for producing a thermoplastic resin film according to claim 4, wherein the first compression surface and the second compression surface of the compression apparatus are two rolls.

7. The process for producing a thermoplastic resin film according to claim 1, wherein a length from the discharge opening of the feeding device to the nip portion is 200 mm or less.

8. The process for producing a thermoplastic resin film according to claim 6, wherein a length from the discharge opening of the feeding device to the nip portion is 200 mm or less.

9. The process for producing a thermoplastic resin film according to claim 1, wherein the molten resin from the discharge opening of the feeding device to the nip portion and the heating apparatus are covered with a shielding member having a thermal insulation function and/or a reflection function.

10. The process for producing a thermoplastic resin film according to claim 8, wherein the molten resin from the discharge opening of the feeding device to the nip portion and the heating apparatus are covered with a shielding member having a thermal insulation function and/or a reflection function.

11. The process for producing a thermoplastic resin film according to claim 1, wherein the film produced has a thickness between 20 μm or more and 100 μm or less, and in-plane retardation is between 20 nm or more and 200 nm or less.

12. The process for producing a thermoplastic resin film according to claim 10, wherein the film produced has a thickness between 20 μm or more and 100 μm or less, and in-plane retardation is between 20 nm or more and 200 nm or less.
